(19) United States
(12) Patent Application Publication
(10) Pub. No.: US 2026/0153769 A1
(43) Pub. Date: Jun. 4, 2026

(54) DISPLAY APPARATUS AND METHOD FOR CONTROLLING THE SAME

(71) Applicant: SAMSUNG ELECTRONICS CO., LTD., Suwon-si (KR)

(72) Inventors: Sungyeol KIM, Suwon-si (KR); Kyehoon LEE, Suwon-si (KR); Junsung CHOI, Suwon-si (KR)

(73) Assignee: SAMSUNG ELECTRONICS CO., LTD., Suwon-si (KR)

(21) Appl. No.: 19/377,790

(22) Filed: Nov. 3, 2025

Related U.S. Application Data
(63) Continuation of application No. PCT/KR2025/015298, filed on Sep. 29, 2025.

(30) Foreign Application Priority Data
Dec. 4, 2024 (KR) 10-2024-0179006

(51) Int. Cl. G02F 1/1335; G02F 1/13357

(52) U.S. Cl. CPC G02F 1/133613; G02F 1/133603; G02F 1/133611; G02F 1/133614

(57) ABSTRACT

A display apparatus includes: a liquid crystal panel, a backlight unit configured to provide light to the liquid crystal panel, a quantum dot (QD) sheet arranged the liquid crystal panel and the backlight unit, and a processor configured to control the liquid crystal panel and the backlight unit. The backlight unit may include a substrate and a plurality of dimming blocks arranged in a plurality of rows and columns and each including a red light-emitting diode (LED), a green LED, and a blue LED. The processor may be configured to, based on an ON signal of an LED having a color identical to a color of QD particles of the QD sheet, control the backlight unit to turn the blue LED on together with the LED that receives the ON signal.

### CROSS-REFERENCE TO RELATED APPLICATIONS

This application is a continuation of International Application No. PCT/KR2025/015298, filed on September 29, 2025, which is based on and claims priority to Korean Patent Application No. 10-2024-0179006, filed on December 4, 2024, in the Korean Intellectual Property Office, the disclosures of which are incorporated by reference herein in their entireties.

### BACKGROUND

### 1. Field

The disclosure relates to a display apparatus and a method for controlling the same, and more particularly, to a display apparatus including a liquid crystal panel and a backlight unit, and a method for controlling the same.

### 2. Description of Related Art

In general, a display apparatus converts acquired or stored electrical information into visual information to display the visual information for users. The display apparatus is widely used in various fields, such as at home or places of business.

The display apparatus includes a backlight unit (BLU) that provides light to a liquid crystal panel, and the backlight unit includes a plurality of point light-emitting devices that may independently emit light. The light-emitting devices include, for example, light-emitting diodes (LEDs) or organic light-emitting diodes (OLEDs).

Local dimming technology used in the backlight unit of an LED TV is a key technology for improving the contrast ratio of the display. A local dimming system divides a display screen into several zones and independently controls current for each zone according to an input image. Accordingly, the local dimming system reduces current when an input image is dark and increases current when an input image is bright, thereby effectively improving the contrast ratio.

### SUMMARY

Provided are a display apparatus that may increase light efficiency of green LED or red LED by combining a backlight unit including red, green, and blue LEDs with a quantum dot sheet, and a method for controlling the same.

In addition, provided is a display apparatus that may reduce power consumption due to increased light efficiency.

Additional aspects will be set forth in part in the description which follows and, in part, will be apparent from the description, or may be learned by practice of the presented embodiments.

According to an aspect of the disclosure, there is provided a display apparatus including: a liquid crystal panel; a backlight unit configured to provide light to the liquid crystal panel; a quantum dot (QD) sheet between the liquid crystal panel and the backlight unit, and including QD particles; and at least one processor configured to control the liquid crystal panel and the backlight unit, wherein the backlight unit includes: a substrate; and a plurality of light-emitting devices, each of the plurality of light-emitting devices including a red light-emitting diode (LED), a green LED, and a blue LED, and the at least one processor is further configured to, based on an ON signal of an LED having a color identical to a color of the QD particles of the QD sheet, control the backlight unit to turn on the blue LED and the LED that receives the ON signal, and the LED having the color identical to the color of the QD particles of the QD sheet is one of the red LED and the green LED.

According to an aspect of the disclosure, there is provided a method for controlling a display apparatus including a liquid crystal panel, a backlight unit configured to provide light to the liquid crystal panel and including a plurality of light-emitting devices,, and a quantum dot (QD) sheet between the liquid crystal panel and the backlight unit and including QD particles, each of the plurality of light-emitting devices including a red light-emitting diode (LED), a green LED, and a blue LED, the method including: receiving an ON signal of an LED having a color identical to a color of the QD particles of the QD sheet, the LED having the color identical to the color of the QD particles of the QD sheet is one of the red LED and the green LED; and controlling the backlight unit to turn on the blue LED and the LED that receives the ON signal, based on the ON signal of the LED having the color identical to the color of the QD particles of the QD sheet.

### BRIEF DESCRIPTION OF THE DRAWINGS

The above and other aspects, features, and advantages of specific embodiments of the present disclosure will be more apparent from the following description with reference to the accompanying drawings, in which:

FIG. 1 illustrates an example of an appearance of a display apparatus according to one or more embodiments;

FIG. 2 illustrates an example of a configuration of a display apparatus according to one or more embodiments;

FIG. 3 illustrates an example of a liquid crystal panel included in a display apparatus according to one or more embodiments;

FIG. 4 illustrates an example of a backlight unit included in a display apparatus according to one or more embodiments;

FIG. 5 is a diagram illustrating that a plurality of LEDs of a backlight unit are divided into dimming blocks according to one or more embodiments;

FIG. 6 is a control block diagram of a display apparatus according to one or more embodiments;

FIG. 7 illustrates an example in which a display apparatus converts image data into dimming data according to one or more embodiments;

FIG. 8 illustrates an example of a light-emitting device included in a backlight unit according to one or more embodiments;

FIG. 9 is a diagram illustrating an arrangement of light-emitting devices included in a backlight unit according to one or more embodiments;

FIG. 10 is a diagram illustrating an arrangement of a backlight unit, quantum dot (QD) sheet, and liquid crystal panel according to one or more embodiments;

FIG. 11 illustrates an LED control according to each color signal according to one or more embodiments;

FIG. 12 is a flowchart illustrating a method for controlling a display apparatus according to one or more embodiments;

FIG. 13 is a diagram illustrating an arrangement of a backlight unit, QD sheet, and liquid crystal panel according to one or more embodiments;

FIG. 14 illustrates an LED control according to each color signal according to one or more embodiments;

FIG. 15 is a flowchart illustrating a method for controlling a display apparatus according to one or more embodiments; and

FIG. 16 is a diagram illustrating an arrangement of a backlight unit, QD sheet, and liquid crystal panel according to one or more embodiments.

### DETAILED DESCRIPTION

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

The terms used herein are used only to describe particular embodiments and are not intended to limit the disclosure. It is to be understood that the singular forms are intended to include the plural forms as well, unless the context clearly dictates otherwise. It will be understood that the terms “include” and “have,” are intended to indicate the presence of the features, numbers, steps, operations, components, parts, or combinations thereof disclosed in the disclosure, but do not preclude the presence or addition of one or more other elements.

When an element is referred to as being “coupled,” or “connected”, to another element, the first element may be connected to the second element, directly, wirelessly, or through a third element.

It will be understood that, although the terms including ordinal numbers, such as “first”, “second”, etc., may be used herein to describe various components, these components should not be limited by these terms. These terms are only used to distinguish one component from another. For example, a first component could be termed a second component, and, similarly, a second component could be termed a first component, without departing from the scope of the disclosure. As used herein, the term “and/or” includes any and all combinations of one or more of associated listed items.

Hereinafter, embodiments of the disclosure will be described in detail with reference to the accompanying drawings.

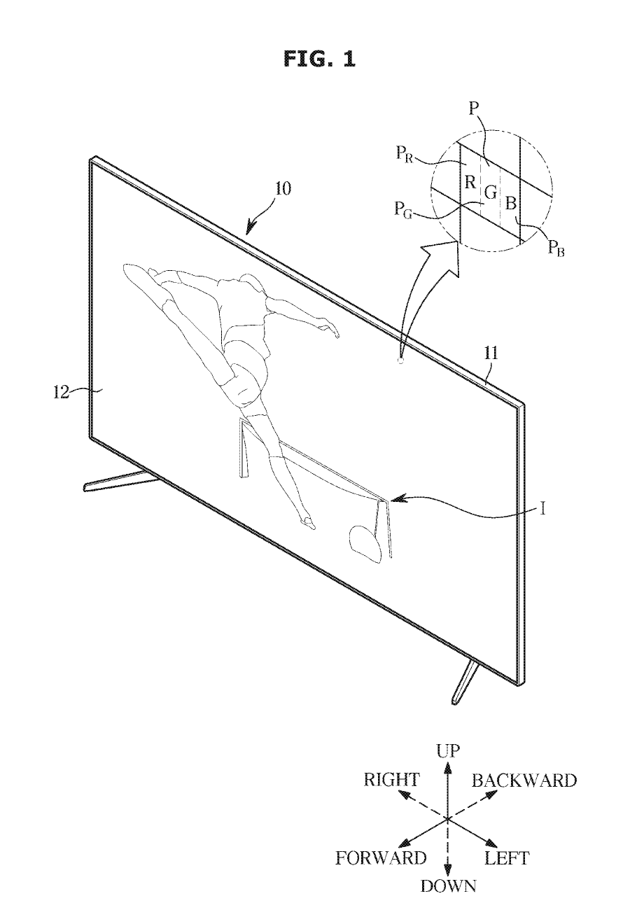

FIG. 1 illustrates an example of an appearance of a display apparatus according to one or more embodiments.

Referring to FIG. 1, a display apparatus 10 is a device capable of processing an image signal received from the outside and visually displaying a processed image. Hereinafter, a case in which the display apparatus 10 is a television (TV) is exemplified, but is not limited thereto. For example, the display apparatus 10 may be implemented in various forms, such as a monitor, a portable multimedia device, a portable communication device, and the like, and the form of the display apparatus 10 is not limited as long as it is a device that visually displays an image.

In addition, the display apparatus 10 may be a large format display (LFD) installed outdoors, such as a building rooftop or a bus stop. Here, the outdoors is not necessarily limited to an outdoor space, and the display apparatus 10 according to one or more embodiments may be installed wherever a large number of people may come and go, even indoors such as at subway stations, shopping malls, movie theaters, office buildings, and stores.

The display apparatus 10 may receive content including a video signal and an audio signal from various content sources, and output video and audio corresponding to the video signal and the audio signal, respectively. For example, the display apparatus 10 may receive content data through a broadcast reception antenna or a wired cable, receive content data from a content playback apparatus, or receive content data from a content-providing server of a content provider.

As shown in FIG. 1, the display apparatus 10 may include a main body 11 and a screen 12 for displaying an image I.

The main body 11 forms an exterior of the display apparatus 10, and components for the display apparatus 10 to display the image I or perform various functions may be provided inside the main body 11. The main body 11 shown in FIG. 1 has a flat plate shape, but the shape of the main body 11 is not limited to that shown in FIG. 1. For example, the main body 11 may have a curved plate shape.

The screen 12 is formed on a front surface of the main body 11, and may display the image I. For example, the screen 12 may display a still image or a video. In addition, the screen 12 may display a two-dimensional plane image or a three-dimensional stereoscopic image using binocular parallax of a user.

The screen 12 may include a liquid crystal panel capable of transmitting or blocking light emitted by a BLU, or the like.

A plurality of pixels P may be formed on the screen 12, and the image I displayed on the screen 12 may be formed by light emitted from each of the plurality of pixels P. For example, the image I may be formed on the screen 12 by combining light emitted from each of the plurality of pixels P like a mosaic.

Each of the plurality of pixels P may emit light of various brightness and various colors. In order to emit light of various colors, each of the plurality of pixels P may include sub-pixels PR, PG, and PB.

The sub-pixels PR, PG, and PB may include a red sub-pixel PR capable of emitting red light, a green sub-pixel PG capable of emitting green light, and a blue sub-pixel PB capable of emitting blue light. For example, the red light may represent light having a wavelength of approximately 700 nm (nanometer, one billionth of a meter) to 800 nm. The green light may represent light having a wavelength of approximately 500 nm to 600 nm. The blue light may represent light having a wavelength of approximately 400 nm to 500 nm.

By combining the red light of the red sub-pixel PR, the green light of the green sub-pixel PG, and the blue light of the blue sub-pixel PB, light of various brightness and various colors may be emitted from each of the plurality of pixels P.

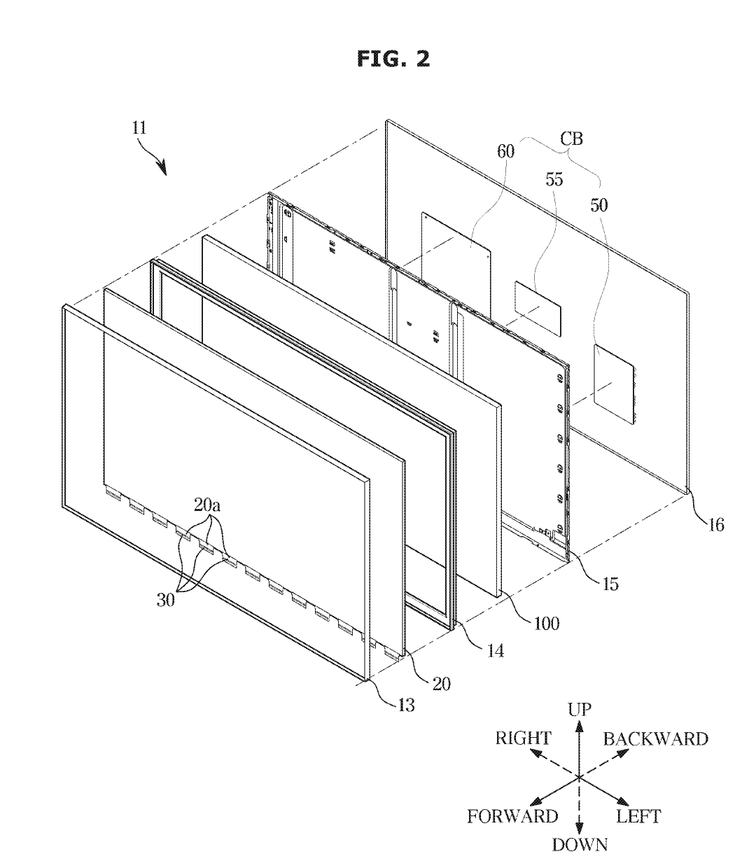

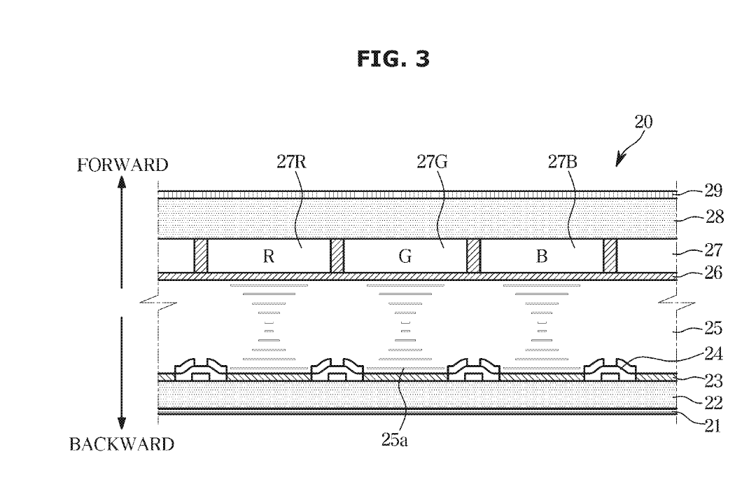

FIG. 2 illustrates an example of a configuration of a display apparatus according to one or more embodiments, and FIG. 3 illustrates an example of a liquid crystal panel included in a display apparatus according to one or more embodiments.

As shown in FIG. 2, various components for generating an image I on the screen 12 may be provided in the main body 11.

For example, the main body 11 may include a backlight unit (or light source apparatus) 100 which is a surface light source, a liquid crystal panel 20 blocking or transmitting light emitted from the backlight unit 100, a control assembly 50 controlling operations of the backlight unit 100 and the liquid crystal panel 20, and a power assembly 60 supplying power to the backlight unit 100 and the liquid crystal panel 20. In addition, the main body 11 may include a bezel 13, a frame middle mold 14, a bottom chassis 15, and a rear cover 16 for supporting the liquid crystal panel 20, the backlight unit 100, the control assembly 50, and the power assembly 60.

The backlight unit 100 may include a point light source that emits white light. In addition, the backlight unit 100 may refract, reflect, and scatter the light to convert the light emitted from the point light source into a uniform surface light. As described above, the backlight unit 100 may refract, reflect, and scatter the light emitted from the point light source to emit a uniform surface light in a forward direction.

The backlight unit 100 will be described in more detail below.

The liquid crystal panel 20 is provided in front of the backlight unit 100, and blocks or transmits light emitted from the backlight unit 100 to form the image I.

A front surface of the liquid crystal panel 20 forms the screen 12 of the display apparatus 10 described above, and the liquid crystal panel 20 may form the plurality of pixels P. The plurality of pixels P of the liquid crystal panel 20 may independently block or transmit the light of the backlight unit 100. In addition, the light transmitted by the plurality of pixels P may form the image I to be displayed on the screen 12.

For example, as shown in FIG. 3, the liquid crystal panel 20 may include a first polarizing film 21, a first transparent substrate 22, a pixel electrode 23, a thin film transistor 24, a liquid crystal layer 25, a common electrode 26, a color filter 27, a second transparent substrate 28, and a second polarizing film 29.

The first transparent substrate 22 and the second transparent substrate 28 may fixedly support the pixel electrode 23, the thin film transistor 24, the liquid crystal layer 25, the common electrode 26, and the color filter 27. The first transparent substrate 22 and the second transparent substrate 28 may be formed of tempered glass or transparent resin.

The first polarizing film 21 and the second polarizing film 29 are provided on outer sides of the first transparent substrate 22 and the second transparent substrate 28 . The first polarizing film 21 and the second polarizing film 29 may each transmit specific polarized light and block (reflect or absorb) the other polarized light. For example, the first polarizing film 21 may transmit light polarized in a first direction and block (reflect or absorb) the other polarized light. In addition, the second polarizing film 29 may transmit light polarized in a second direction and block (reflect or absorb) the other polarized light. In this instance, the first direction and the second direction may be orthogonal to each other. Thus, the polarized light passing through the first polarizing film 21 may not directly pass through the second polarizing film 29.

The color filter 27 may be provided on an inner side of the second transparent substrate 28. The color filter 27 may include, for example, a red filter 27R transmitting red light, a green filter 27G transmitting green light, and a blue filter 27B transmitting blue light. In addition, the red filter 27R, the green filter 27G, and the blue filter 27B may be arranged side by side. A region occupied by the color filter 27 corresponds to the pixel P described above. A region occupied by the red filter 27R corresponds to the red sub-pixel PR, a region occupied by the green filter 27G corresponds to the green sub-pixel PG, and a region occupied by the blue filter 27B corresponds to the blue sub-pixel PB.

The pixel electrode 23 may be provided on an inner side of the first transparent substrate 22, and the common electrode 26 may be provided on the inner side of the second transparent substrate 28. The pixel electrode 23 and the common electrode 26 are formed of a metal material through which electricity is conducted, and may generate an electric field for changing the arrangement of liquid crystal molecules 25a constituting the liquid crystal layer 25 to be described below.

The thin film transistor (TFT) 24 is provided on the inner side of the second transparent substrate 28. The TFT 24 may be turned on (closed) or off (opened) by image data provided from a panel driver 30. In addition, by turning the TFT 24 on (closing) or off (opening), an electric field may be formed or removed from between the pixel electrode 23 and the common electrode 26.

The liquid crystal layer 25 is formed between the pixel electrode 23 and the common electrode 26 and is filled with liquid crystal molecules 25a. The liquid crystal may represent an intermediate state between a solid (crystal) and a liquid. The liquid crystal may exhibit optical properties depending on a change in electric field. For example, a direction of the molecular arrangement constituting the liquid crystal may change depending on a change in electric field. As a result, optical properties of the liquid crystal layer 25 may change according to the presence or absence of the electric field passing through the liquid crystal layer 25. For example, the liquid crystal layer 25 may rotate a polarization direction of light about an optical axis according to the presence or absence of the electric field. Accordingly, the polarized light that has passed through the first polarizing film 21 is changed in polarization direction while passing through the liquid crystal layer 25, and may pass through the second polarizing film 29.

At one edge of the liquid crystal panel 20, a cable 20a through which image data is transmitted to the liquid crystal panel 20 and a display driver integrated circuit (DDI) 30 (hereinafter, referred to as the “panel driver”) that processes digital image data and outputs an analog image signal are provided.

The cable 20a may electrically connect between the control assembly 50/the power assembly 60 and the panel driver 30, and may also electrically connect the panel driver 30 and the liquid crystal panel 20. The cable 20a may include a flexible flat cable or a film cable that may be bendable.

The panel driver 30 may receive image data and power from the control assembly 50/the power assembly 60 through the cable 20a. Further, the panel driver 30 may provide image data and driving current to the liquid crystal panel 20 through the cable 20a.

In addition, the cable 20a and the panel driver 30 may be integrally implemented as a film cable, a chip on film (COF), a TCP, or the like. In other words, the panel driver 30 may be disposed on the cable 20a. However, the disclosure is not limited thereto, and the panel driver 30 may be disposed on the liquid crystal panel 20.

The control assembly 50 may include a control circuit that controls operations of the liquid crystal panel 20 and the backlight unit 100. For example, the control circuit may process a video signal and/or an audio signal received from an external content source. The control circuit may transmit the image data to the liquid crystal panel 20, and may transmit dimming data to the backlight unit 100.

The power assembly 60 may include a power circuit supplying power to the liquid crystal panel 20 and the backlight unit 100. The power circuit may supply power to the control assembly 50, the backlight unit 100, and the liquid crystal panel 20.

The control assembly 50 and the power assembly 60 may be implemented with a printed circuit board and various circuits mounted on the printed circuit board. For example, the power circuit may include a condenser, a coil, a resistance element, a processor, and the like and a power circuit board on which these elements are mounted. In addition, the control circuit may include a memory, a processor, and a control circuit board on which these elements are mounted.

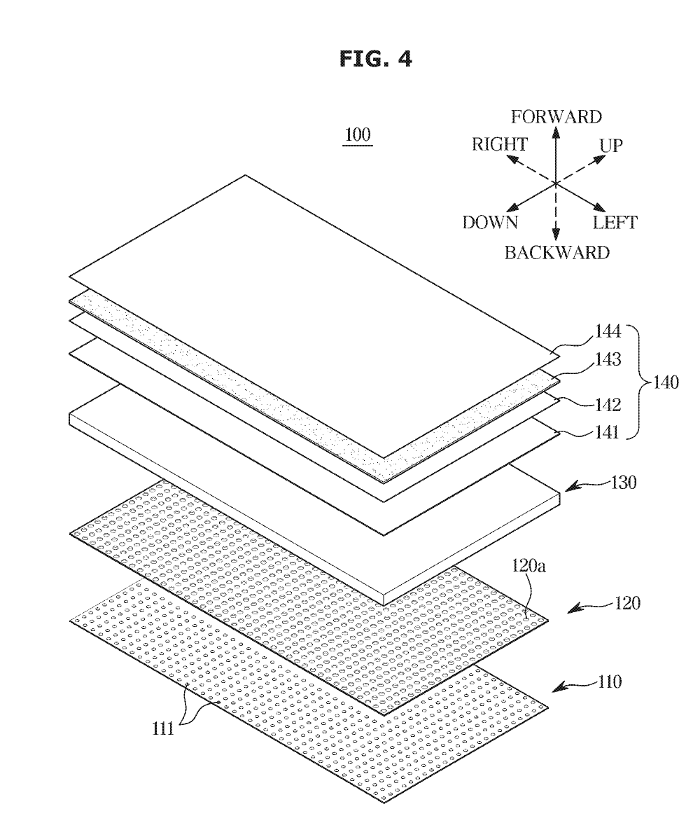

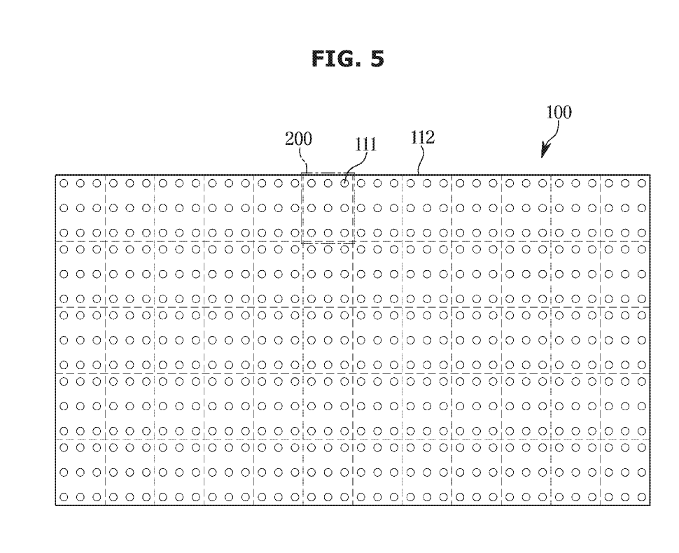

FIG. 4 illustrates an example of the backlight unit 100 included in the display apparatus 10, and FIG. 5 is a diagram illustrating that a plurality of LEDs of the backlight unit 100 are divided into dimming blocks according to one or more embodiments.

As shown in FIG. 4, the backlight unit 100 may include a light source module 110 generating light, a reflector sheet 120 reflecting light, a diffuser plate 130 uniformly diffusing light, and an optical sheet 140 improving luminance of the output light.

As shown in FIG. 4 and FIG. 5 for example, the light source module 110 may include a plurality of light-emitting devices 111 emitting light, and a substrate 112 supporting/fixing the plurality of light-emitting devices 111.

The plurality of light-emitting devices 111 may be arranged in a predetermined pattern to allow light to be emitted with uniform luminance. The plurality of light-emitting devices 111 may be arranged to allow a distance between a single light source and each light source adjacent thereto to be the same.

For example, as shown in FIG. 4, the plurality of light-emitting devices 111 may be aligned in rows and columns. For example, the plurality of light sources may be arranged to form an approximate square by four adjacent light sources. In addition, any one light source is disposed adjacent to four light sources, and a distance between the single light source and each of the four light sources adjacent to the single light source may be substantially the same.

Furthermore, according to one or more embodiments, the plurality of light sources may be arranged such that three adjacent light sources form a substantially equilateral triangle. In this case, a single light source may be disposed adjacent to six light sources. In addition, a distance between the single light source and each of the six adjacent light sources may be substantially the same.

However, the arrangement in which the plurality of light-emitting devices 111 are disposed is not limited to the arrangement described above, and the plurality of light-emitting devices 111 may be disposed in various patterns to allow light to be emitted with uniform luminance.

Each light-emitting device 111 may employ a device capable of emitting monochromatic light (light having a specific range of wavelengths, for example, blue light) or white light (for example, mixed light of red light, green light, and blue light) in various directions when power is supplied. For example, the light-emitting device 111 may include an LED. The LED may be implemented in a variety of sizes and may include, for example, mini LEDs and/or micro LEDs.

The substrate 112 may fix the plurality of light-emitting devices 111 to prevent positions of the light-emitting devices 111 from being changed. In addition, the substrate 112 may supply power for enabling the light-emitting devices 111 to emit light to the individual light-emitting devices 111.

The substrate 112 may fix the plurality of light-emitting devices 111, and may include a synthetic resin and/or tempered glass and/or a printed circuit board (PCB) on which a conductive power feed line for supplying power to the light-emitting device 111 is formed.

The reflector sheet 120 may reflect light emitted from the plurality of light-emitting devices 111 in a forward direction or in a direction close to the forward direction.

A plurality of through holes 120a corresponding respectively to the plurality of light-emitting devices 111 of the light source module 110 are formed in the reflector sheet 120. In addition, the light-emitting devices 111 of the light source module 110 may pass through the through holes 120a and protrude forward of the reflector sheet 120.

For example, in an assembly process of the reflector sheet 120 and the light source module 110, the plurality of light-emitting devices 111 of the light source module 110 are inserted into the plurality of through holes 120a formed in the reflector sheet 120. As a result, the substrate 112 of the light source module 110 is located behind the reflector sheet 120, but the plurality of light-emitting devices 111 of the light source module 110 may be located in front of the reflector sheet 120.

Accordingly, the plurality of light-emitting devices 111 may emit light in front of the reflector sheet 120.

The plurality of light-emitting devices 111 may emit light in front of the reflector sheet 120 in various directions. Light may be emitted from the light-emitting device 111 not only toward the diffuser plate 130, but also toward the reflector sheet 120, and the reflector sheet 120 may reflect the light emitted toward the reflector sheet 120 toward the diffuser plate 130.

The light emitted from the light-emitting device 111 passes through various objects such as the diffuser plate 130 and the optical sheet 140. When the light passes the diffuser plate 130 and the optical sheet 140, a portion of the incident light is reflected from surfaces of the diffuser plate 130 and the optical sheet 140. The reflector sheet 120 may reflect the light reflected by the diffuser plate 130 and the optical sheet 140.

The diffuser plate 130 may be disposed in front of the light source module 110 and the reflector sheet 120, and may uniformly disperse the light emitted from the light-emitting device 111 of the light source module 110.

As described above, the plurality of light-emitting devices 111 are located at various positions on a rear surface of the backlight unit 100. Although the plurality of light-emitting devices 111 are equidistantly arranged on the rear surface of the backlight unit 100, non-uniformity of luminance may exist depending on the positions of the plurality of light-emitting devices 111.

To eliminate the non-uniformity of luminance due to the plurality of light-emitting devices 111, the diffuser plate 130 may diffuse the light emitted from the plurality of light-emitting devices 111 within the diffuser plate 130. In other words, the diffuser plate 130 may uniformly emit non-uniform light from the plurality of light-emitting devices 111 to the front surface.

The optical sheet 140 may include various sheets for improving luminance and luminance uniformity. For example, the optical sheet 140 may include a diffuser sheet 141, a first prism sheet 142, a second prism sheet 143, a reflective polarizing sheet 144, and the like.

The diffuser sheet 141 diffuses light for uniformity of luminance. The light emitted from the light-emitting device 111 is diffused by the diffuser plate 130, and may be diffused again by the diffuser sheet 141 included in the optical sheet 140.

The first prism sheet 142 and the second prism sheet 143 may concentrate the light diffused by the diffuser sheet 141, thereby increasing the luminance. The first prism sheet 142 and the second prism sheet 143 include a prism pattern of a triangular prism shape, and a plurality of these prism patterns are arranged adjacent to each other to form a plurality of bands.

The reflective polarizing sheet 144 is a kind of polarizing film, and may transmit a portion of the incident light, and reflect other portions to improve luminance. For example, the reflective polarizing sheet 144 may transmit light polarized in the same direction as a predetermined polarization direction of the reflective polarizing sheet 144 and reflect light polarized in a different direction from the polarization direction of the reflective polarizing sheet 144. In addition, the light reflected by the reflective polarizing sheet 144 is reused within the backlight unit 100, and the luminance of the display apparatus 10 may be improved by such light recycle.

The optical sheet 140 is not limited to the sheets or films shown in FIG. 4, and may further include more various sheets or films such as protective sheets.

The backlight unit 100 includes the plurality of light-emitting devices (or light sources) 111, and may output surface light by diffusing the light emitted from the plurality of light-emitting devices 111. The liquid crystal panel 20 includes a plurality of pixels, and may control the plurality of pixels to allow each of the plurality of pixels to transmit or block light. An image may be formed by light passing through each of the plurality of pixels.

In this instance, the display apparatus 10 may perform local dimming to vary a brightness of light for each region of the backlight unit 100 in association with the output image to improve power consumption while increasing a contrast ratio.

For example, the display apparatus 10 may reduce the brightness of light of the light-emitting device 111 of the backlight unit 100 corresponding to a dark portion of an image to make the dark portion of the image darker, and may increase the brightness of light of the light-emitting device 111 of the backlight unit 100 corresponding to a bright portion of the image to make the bright portion of the image brighter. As a result, a contrast ratio or a brightness ratio of the image may be improved.

The display apparatus 10 may divide the backlight unit 100 into a plurality of blocks, and adjust current independently for each block according to an input image. Image transmission of the display apparatus 10 is performed through a method of frame-by-frame local dimming drives, and the driving of the current is adjusted according to the number of divided blocks of the light-emitting devices 111 in the backlight unit 100.

As a result, the display apparatus 10 may effectively improve a contrast ratio by lowering a supply current to the dimming blocks of regions where the input image is dark and increasing the supply current to the dimming blocks of regions where the input image is bright.

For local dimming, the plurality of light-emitting devices 111 included in the backlight unit 100 may be divided into a plurality of dimming blocks 200. For example, the plurality of dimming blocks 200 may be provided as a total of 60 blocks, composed of five rows and twelve columns, as shown in FIG. 5. As another example, the plurality of dimming blocks 200 may be provided as a total of 20 blocks, composed of five rows and four columns. However, the number of dimming blocks 200 is not limited to the above examples.

Referring to FIG. 5, each of the plurality of dimming blocks 200 may include at least one light-emitting device 111. The backlight unit 100 may supply the same driving current to the light-emitting devices 111 belonging to the same dimming block 200, and the light-emitting devices 111 belonging to the same dimming block 200 may emit light of the same brightness.

In addition, the backlight unit 100 may supply different driving currents to the light-emitting devices 111 belonging to different dimming blocks 200 according to dimming data, and the light-emitting devices 111 belonging to different dimming blocks 200 may emit light of different brightness.

For example, each of the plurality of dimming blocks 200 may include N*M light sources arranged in an N*M matrix form (N and M are natural numbers). The N*M matrix refers to a matrix with N rows and M columns.

Because each of the light-emitting devices 111 includes an LED, each of the plurality of dimming blocks 200 may include N*M LEDs. That is, each of the plurality of dimming blocks 200 may include a predetermined number of light-emitting devices 111.

The plurality of dimming blocks 200 may be disposed on the substrate 112. That is, N*M LEDs may be disposed on the substrate 112.

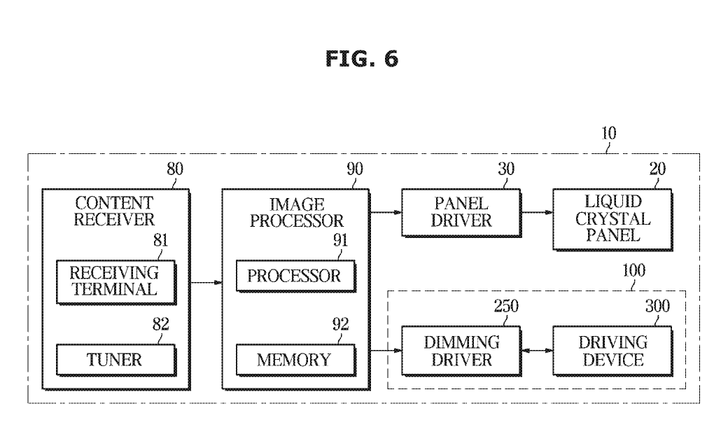

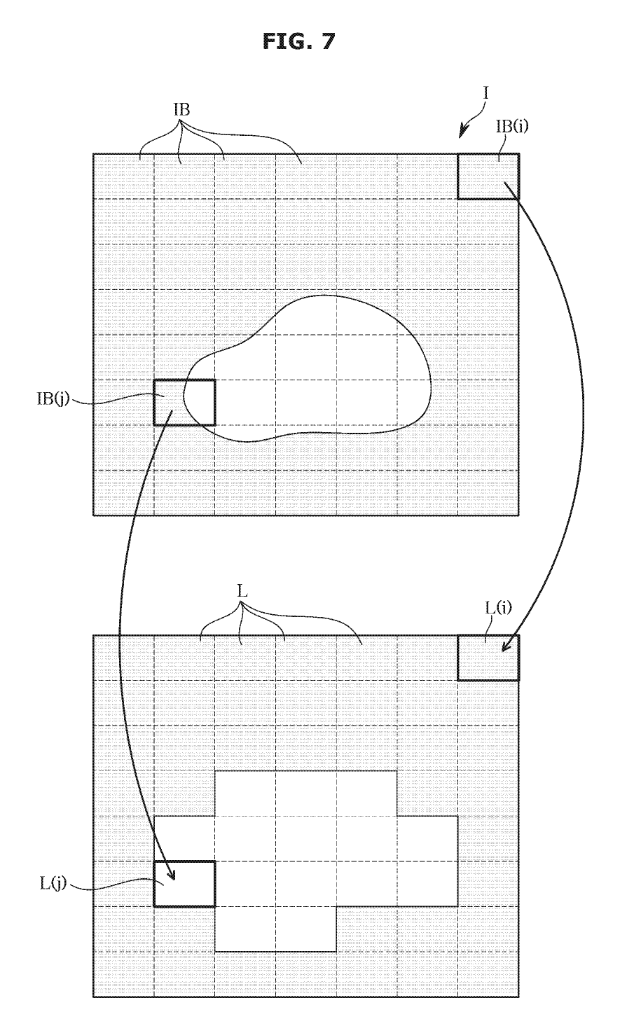

FIG. 6 is a control block diagram of a display apparatus according to one or more embodiments, and FIG. 7 illustrates an example in which a display apparatus converts image data into dimming data according to one or more embodiments.

Referring to FIG. 6, the display apparatus 10 may include a content receiver 80, an image processor 90, the panel driver 30, the liquid crystal panel 20, and the backlight unit 100. In this instance, the backlight unit 100 may include a dimming driver 250 that performs local dimming and a driving device 300 that drives the light-emitting device 111. The driving device 300 may be disposed on an upper surface or a lower surface of the substrate 112.

The content receiver 80 may include a receiving terminal 81 receiving content including a video signal and/or audio signal from content sources, and a tuner 82.

The receiving terminal 81 may receive a video signal and audio signal from content sources through a cable. For example, the receiving terminal 81 may include a component (YPbPr/RGB) terminal, a composite video blanking and sync (CVBS) terminal, an audio terminal, a high definition multimedia interface (HDMI) terminal, a universal serial bus (USB) terminal, and the like.

The tuner 82 may receive a broadcast signal from a broadcast reception antenna or a wired cable, and may extract a broadcast signal of a channel selected by a user from among broadcast signals. For example, the tuner 82 may pass a broadcast signal having a frequency corresponding to the channel selected by the user among a plurality of broadcast signals received through the broadcast reception antenna or wired cable, and may block a broadcast signal having a different frequency.

As described above, the content receiver 80 may receive an image including a video signal and an audio signal from the content sources through the receiving terminal 81 and/or the tuner 82, and may output the input image received through the receiving terminal 81 and/or the tuner 82 to the image processor 90.

The image processor 90 may include at least one processor 91 that processes an input image (image data) and a memory 92 that records/stores data.

The memory 92 stores programs and data for processing a video signal and/or an audio signal, and may temporarily remember data generated while processing the video signal and/or audio signal.

The memory 92 may include a non-volatile memory, such as read only memory (ROM) and flash memory, and a volatile memory, such as S-RAM and D-RAM.

The processor 91, which may be one or more processors according to one or more embodiments, may receive an input image including a video signal and/or an audio signal from the content receiver 80, may decode the video signal into image data, and may generate dimming data from the image data. The image data and the dimming data may be output to the panel driver 30 and the dimming driver 250, respectively.

The processor 91 may provide dimming data for local dimming to the backlight unit 100. The dimming data may include information about a luminance of each of the plurality of dimming blocks 200. For example, the dimming data may include information about an intensity of light output by the light-emitting devices 111 included in each of the plurality of dimming blocks 200. That is, the dimming data may include information about a magnitude of current supplied to the light-emitting devices 111 included in each of the plurality of dimming blocks 200.

The processor 91 may obtain the dimming data from the image data decoded from the video signal.

The processor 91 may convert the image data into the dimming data in various manners. For example, as shown in FIG. 7, the processor 91 may divide an image I based on the image data into a plurality of image blocks IB. The number of the plurality of image blocks IB is equal to the number of the plurality of dimming blocks 200, and the plurality of image blocks IB may each correspond to the plurality of dimming blocks 200.

The processor 91 may obtain luminance values L of the plurality of dimming blocks 200 from the image data of the plurality of image blocks IB. In addition, the processor 91 may generate the dimming data by combining the luminance values L of the plurality of dimming blocks 200.

For example, the processor 91 may obtain a luminance value L of each of the plurality of dimming blocks 200 based on a maximum value among luminance values of pixels included in each of the image blocks IB.

A single image block includes a plurality of pixels, and image data of a single image block may include image data of a plurality of pixels (e.g., red data, green data, blue data, etc.). The processor 91 may calculate the luminance value of each of the pixels based on the image data of each of the pixels.

The processor 91 may determine a maximum value of the luminance values of pixels included in an image block as a luminance value of a dimming block corresponding to the image block. For example, the processor 91 may determine a maximum value of luminance values of pixels included in the i-th image block IB(i) as a luminance value L(i) of an i-th dimming block, and may determine a maximum value of luminance values of pixels included in a j-th image block IB(j) as a luminance value L(j) of a j-th dimming block.

The processor 91 may generate dimming data by combining the luminance values of the plurality of dimming blocks 200.

As such, the image processor 90 may decode the video signal obtained by the content receiver 80 into image data, and may generate the dimming data from the image data. In addition, the image processor 90 may transmit the image data and the dimming data to the liquid crystal panel 20 and the light source apparatus 100, respectively.

The liquid crystal panel 20 includes a plurality of pixels capable of transmitting or blocking light, and the plurality of pixels are arranged in a matrix form. In other words, the plurality of pixels may be arranged in a plurality of rows and a plurality of columns.

The panel driver 30 may receive the image data from the image processor 90 and drive the liquid crystal panel 20 according to the image data. In other words, the panel driver 30 may convert image data, which is a digital signal (hereinafter, referred to as ‘digital image data’), into an analog image signal, which is an analog voltage signal, and may provide the converted analog image signal to the liquid crystal panel 20. Optical properties (e.g., light transmittance) of the plurality of pixels included in the liquid crystal panel 20 may change according to the analog image signal.

The panel driver 30 may include, for example, a timing controller, a data driver, a scan driver, and the like.

The timing controller may receive image data from the image processor 90 and output the image data and a drive control signal to the data driver and the scan driver. The drive control signal may include a scan control signal and a data control signal, and the scan control signal and the data control signal may be used to control operations of the scan driver and the data driver, respectively.

The scan driver may receive a scan control signal from the timing controller, and may input-activate any one of the plurality of rows in the liquid crystal panel 20 according to the scan control signal. In other words, the scan driver may convert pixels, included in a single row among the plurality of pixels arranged in the plurality of rows and the plurality of columns, into a state capable of receiving an analog image signal. In this instance, the other pixels input-deactivated, except for the pixels input-activated by the scan driver, may not receive an analog image signal.

The data driver may receive image data and a data control signal from the timing controller and output the image data to the liquid crystal panel 20 according to the data control signal. For example, the data driver may receive the digital image data from the timing controller and convert the digital image data into an analog image signal. In addition, the data driver may provide the analog image signal to pixels included in any one row input-activated by the scan driver. In this instance, the pixels input-activated by the scan driver receive the analog image signal, and optical properties (e.g., light transmittance) of the input-activated pixels may change according to the received analog image signal.

As described above, the panel driver 30 may drive the liquid crystal panel 20 according to image data. As a result, an image corresponding to the image data may be displayed on the liquid crystal panel 20.

The light source apparatus 100 includes a plurality of light-emitting devices 111 that emit light, and the plurality of light-emitting devices 111 are arranged in a matrix form. In other words, the plurality of light-emitting devices 111 may be arranged in a plurality of rows and a plurality of columns. In addition, the light source apparatus 100 may be divided into a plurality of dimming blocks 200, and each of the plurality of dimming blocks 200 may include at least one light source.

The dimming driver 250 may receive dimming data from the image processor 90 and drive the light source apparatus 100 according to the dimming data. Here, the dimming data may include information about a luminance of each of the plurality of dimming blocks 200 or information about a brightness of the light sources included in each of the plurality of dimming blocks 200.

The dimming driver 250 may convert the dimming data, which is a digital signal (hereinafter, referred to as ‘digital dimming data’), into an analog dimming signal, which is an analog voltage signal, and may provide the analog dimming signal to the light source apparatus 100. According to the analog dimming signal, an intensity of light emitted by the light sources included in each of the plurality of dimming blocks 200 may change.

In particular, the dimming driver 250 may provide the analog dimming signal sequentially to the plurality of dimming blocks 200 by an active matrix method, instead of directly providing the analog dimming signal to all of the plurality of dimming blocks 200.

As described above, the plurality of dimming blocks 200 may be arranged in a matrix form in the light source apparatus 100. In other words, the plurality of dimming blocks 200 may be arranged in a plurality of rows and a plurality of columns in the light source apparatus 100.

The dimming driver 250 may provide the analog dimming signal sequentially to dimming blocks belonging to each of the plurality of rows or to dimming blocks belonging to each of the plurality of columns.

For example, the dimming driver 250 may input-activate dimming blocks belonging to any one row of the plurality of dimming blocks 200, and may provide the analog dimming signal to the input-activated dimming blocks. Thereafter, the dimming driver 250 may input-activate dimming blocks belonging to another row of the plurality of dimming blocks 200, and may provide the analog dimming signal to the input-activated dimming blocks.

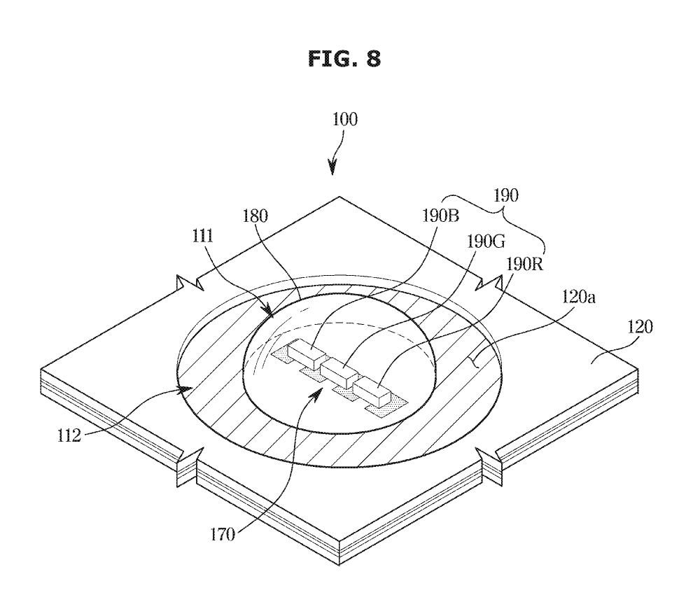

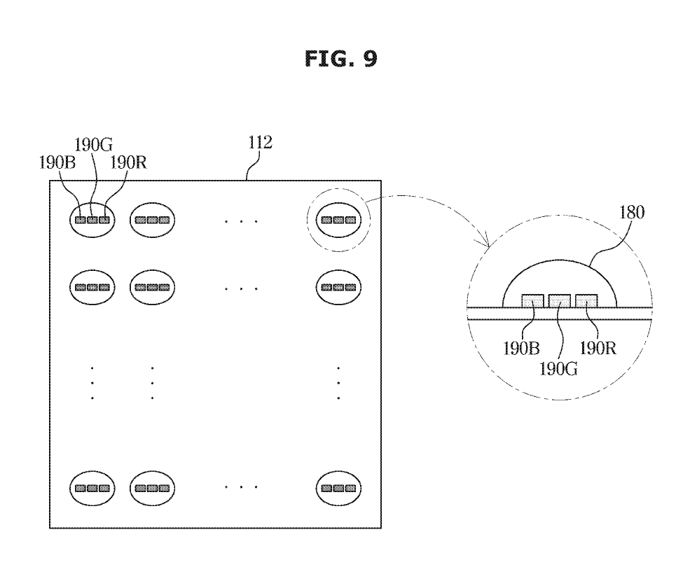

FIG. 8 illustrates an example of a light-emitting device included in a backlight unit according to one or more embodiments. FIG. 9 is a diagram illustrating an arrangement of light-emitting devices included in a backlight unit according to one or more embodiments.

A single light-emitting device 111 may include a single LED group 170. That is, a single light-emitting device 111 may include a red LED 190R, a green LED 190G, and a blue LED 190B, as shown in FIG. 8.

A plurality of LED groups 170 may be arranged in a two-dimensional matrix form on the upper surface of the substrate 112. That is, as shown in FIG. 4, as a plurality of light-emitting devices 111 are arranged in rows and columns, the plurality of LED groups 170 may be arranged in a two-dimensional matrix form.

Furthermore, according to embodiments, the plurality of light sources may be arranged such that three adjacent light sources form a substantially equilateral triangle. In this case, a single light source may be disposed adjacent to six light sources. In addition, a distance between the single light source and each of the six adjacent light sources may be substantially the same.

However, the arrangement in which the plurality of light-emitting devices 111 are disposed is not limited to the arrangement described above, and the plurality of light-emitting devices 111 may be disposed in various patterns to allow light to be emitted with uniform luminance.

Each light-emitting device 111 may employ a device capable of emitting white light (for example, mixed light of red light, green light, and blue light) in various directions when power is supplied.

That is, a single light emitting device 111 may emit white light by including the red LED 190R, the green LED 190G, and the blue LED 190B.

As shown in FIG. 8, each of the plurality of light-emitting devices 111 may include an LED group 170 and an optical dome 180.

The backlight unit 100 may have a small thickness to allow the display apparatus 10 to have a small thickness. To reduce the thickness of the backlight unit 100, each of the plurality of light-emitting devices 111 may have a small thickness and a simple structure.

The LEDs, such as the red LED 190R, the green LED 190G, and the blue LED 190B, of the LED group 170 may be directly attached to the substrate 112 by a chip on board (COB) method. For example, the light-emitting device 111 may include an LED 190 formed by attaching an LED chip or an LED die directly to the substrate 112 without separate packaging.

The LED 190 may be manufactured as a flip-chip type. The LED 190 of the flip chip type may be formed by welding, upon attaching an LED being a semiconductor device to the substrate 112, an electrode pattern of a semiconductor device as it is to the substrate 112 without using a middle medium, such as a metal lead (wire) or a ball grid array (BGA). As such, by using neither a metal lead (wire) nor a ball grid array, the light-emitting device 111 including the LED 190 of the flip chip type may be miniaturized.

Although the flip-chip type LED 190 welded directly to the substrate 112 by the chip on board method has been described above, the light-emitting device 111 is not limited to the flip-chip type LED. For example, the light-emitting device 111 may include a package-type LED.

The optical dome 180 may cover the LED group 170. That is, the optical dome 180 may cover the red LED 190R, the green LED 190G, and the blue LED 190B included in the LED group 170.

The optical dome 180 may refract red light, green light, and blue light respectively emitted from the red LED 190R, the green LED 190G, and the blue LED 190B to mix the red light, green light, and blue light, thereby emitting white light.

As such, the optical dome 180 may emit white light by mixing red light, green light, and blue light, and reduce a distance required for mixing to white light, compared to a case in which no optical dome 180 exists, thereby reducing an optical distance (OD) required for changing point light sources to a surface light source.

In addition, the optical dome 180 may prevent or suppress the LEDs 190 from being damaged by a mechanical action from outside and/or by a chemical action.

The optical dome 180 may be in a shape of a dome resulting from cutting, for example, a sphere with a plane not including a center of the sphere, or in a shape of a hemisphere resulting from cutting a sphere with a plane including a center of the sphere. A vertical section of the optical dome 180 may be in a shape of, for example, a segment of a circle or a semicircle.

The optical dome 180 may be formed of silicon or epoxy resin. For example, the optical dome 180 may be formed by discharging molten silicon or a molten epoxy resin onto the LEDs 190 through a nozzle, etc. and then hardening the silicon or epoxy resin.

The optical dome 180 may be optically transparent or translucent. Light emitted from the LED 190 may pass through the optical dome 180 and be emitted to the outside.

In this instance, the dome-shaped optical dome 180 may refract light, like a lens. For example, light emitted from the LEDs 190 may be refracted by the optical dome 180 and dispersed.

As such, the optical dome 180 may not only protect the LEDs 190 from external mechanical action and/or chemical action or electrical action, but also disperse light emitted from the LEDs 190.

Although the optical dome 180 in the form of a silicon dome has been described above, the light-emitting device 111 is not limited to including the optical dome 180. For example, the light-emitting device 111 may include a lens for dispersing light emitted from the LEDs.

A plurality of light-emitting devices 111 including the red LED 190R, the green LED 190G, and the blue LED 190B are arranged on a substrate, a predetermined number of light-emitting devices 111 form a single dimming block 200, and thus these plurality of dimming blocks 200 may be arranged in a two-dimensional matrix.

As described above, according to the disclosure, because each light-emitting device 111 includes the red LED 190R, the green LED 190G, and the blue LED 190B, higher color purity, a higher contrast ratio, and higher image quality may be achieved than in local dimming using single light.

The red LED 190R, the green LED 190G, and the blue LED 190B may each have different light efficiencies. For example, the blue LED 190B may have the highest light-emitting efficiency. That is, the blue LED 190B may consume the least power when generating the same light.

Hereinafter, a method for reducing power consumption by driving a display apparatus with the highest light-emitting efficiency based on differences in light efficiency according to a color of an LED is described.

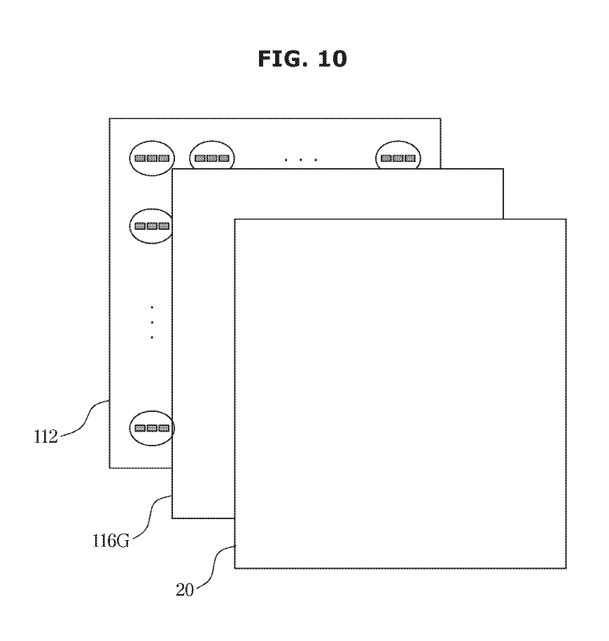

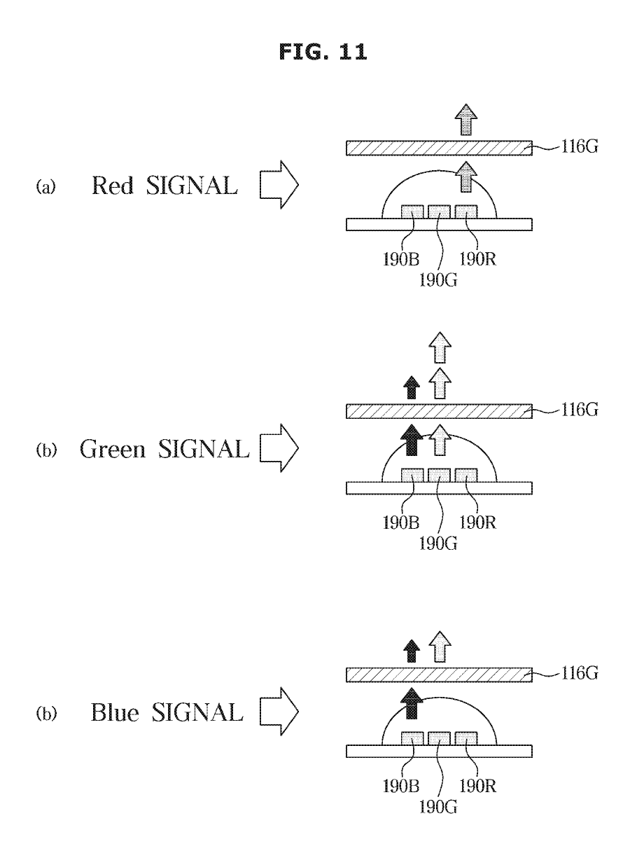

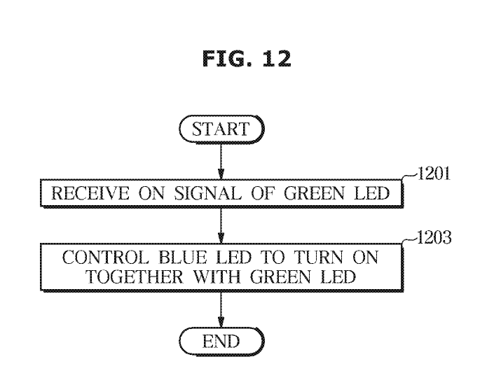

FIG. 10 is a diagram illustrating an arrangement of a backlight unit, quantum dot sheet, and liquid crystal panel according to one or more embodiments. FIG. 11 illustrates an LED control according to each color signal according to one or more embodiments. FIG. 12 is a flowchart illustrating a method for controlling a display apparatus according to one or more embodiments.

The display apparatus may further include a QD sheet arranged between the liquid crystal panel 20 and the backlight unit 100, in addition to the liquid crystal panel 20 and the backlight unit 100 for providing light to the liquid crystal panel.

When light of a specific wavelength (energy) is incident on a QD, the QD may generate light of a specific wavelength according to the color of QD particles.

Based on an ON signal of an LED having the same color as the color of the QD particles of a QD sheet 116, the processor 91 may control the backlight unit 100 to turn the blue LED on together with the LED receiving the ON signal.

Hereinafter, the QD sheet 116 is described as a QD sheet 116G of green QD particles.

In this case, based on receiving an ON signal of the green LED 190G (1201), the processor 91 may control the blue LED 190B to turn on together with the green LED 190G (1203).

Referring to FIG. 11, when an ON signal of the red LED 190R is received as shown in FIG. 11 (a), the processor 91 may control only the red LED 190R to turn on.

In addition, when an ON signal of the blue LED 190B is received, as shown in FIG. 11 (c), the processor 91 may control only the blue LED 190B to turn on.

However, when an ON signal of the green LED 190G is received as shown in FIG. 11 (b), the processor 91 may control both the green LED 190G and the blue LED 190B to turn on.

When the blue light generated from the blue LED 190B passes through the QD sheet 116G including the green QD particles, green light is generated from the QD sheet 116G of the green QD particles. Accordingly, by driving the blue LED, which is relatively efficient in generating the same green light, together with the green LED 190G, power consumption may be reduced compared to generating green light by driving only the green LED 190G.

In other words, compared to generating green light using only the green LED 190G, light efficiency may be increased by driving the green LED 190G at a relatively low current while simultaneously driving the more efficient blue LED 190B.

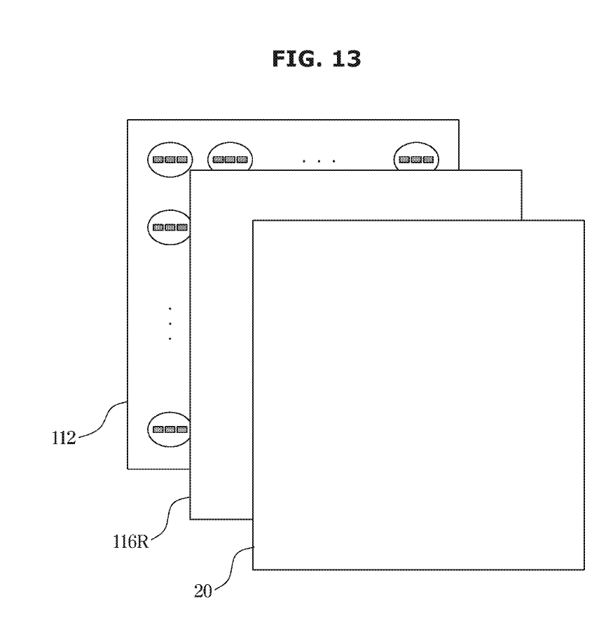

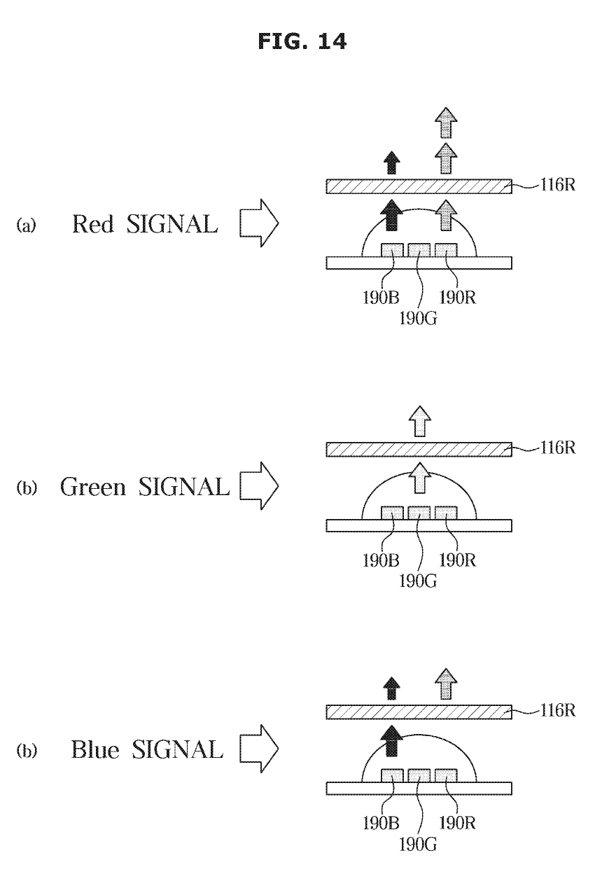

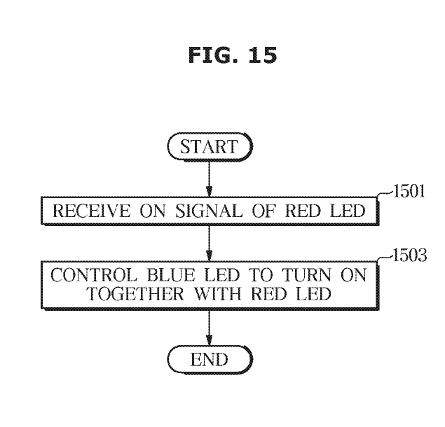

FIG. 13 is a diagram illustrating an arrangement of a backlight unit, QD sheet, and liquid crystal panel according to one or more embodiments. FIG. 14 illustrates an LED control according to each color signal according to one or more embodiments. FIG. 15 is a flowchart illustrating a method for controlling a display apparatus according to one or more embodiments.

As described above, based on an ON signal of an LED having the same color as the color of QD particles of the QD sheet 116, the processor 91 may control the backlight unit 100 to turn the blue LED on together with the LED receiving the ON signal.

Hereinafter, the QD sheet 116 is described as a QD sheet 116R of red QD particles.

In this case, based on receiving an ON signal of the red LED 190R (1501), the processor may control the red LED 190R and the blue LED 190B to turn on (1503).

Referring to FIG. 14, when an ON signal of the green LED 190G is received as shown in FIG. 14 (b), the processor 91 may control only the green LED 190G to turn on.

In addition, as shown in FIG. 14 (c), when an ON signal of the blue LED 190B is received, the processor 91 may control only the blue LED 190B to turn on.

However, as shown in FIG. 14 (a), when an ON signal of the red LED 190R is received, the processor 91 may control both the red LED 190R and the blue LED 190B to turn on.

When the blue light generated from the red LED 190R passes through the QD sheet 116R including the red QD particles, red light is generated from the QD sheet 116R of the red QD particles. Accordingly, by driving the blue LED, which is relatively efficient in generating the same red light, together with the red LED, power consumption may be reduced compared to generating red light by driving only the red LED 190R.

In other words, compared to generating red light using only the red LED 190R, light efficiency may be increased by driving the red LED 190R at a relatively low current while simultaneously driving the more efficient blue LED 190B.

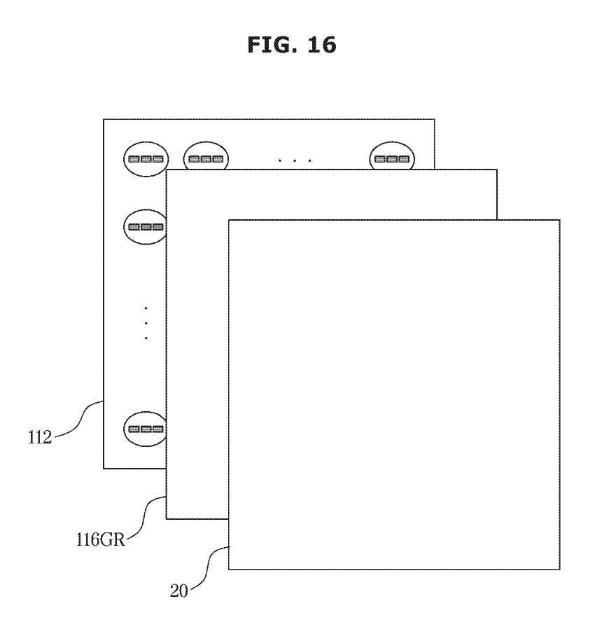

FIG. 16 is a diagram illustrating an arrangement of a backlight unit, QD sheet, and liquid crystal panel according to one or more embodiments.

Hereinafter, the QD sheet 116 is described as a QD sheet 116GR of green QD particles and red QD particles.

In this case, based on receiving an ON signal of the red LED 190R, the processor may control both the red LED 190R and the blue LED 190B to turn on. In addition, based on receiving an ON signal of the green LED 190G, the processor may control both the green LED 190G and the blue LED 190B to turn on.

That is, when an ON signal of the blue LED 190B is received, the processor 91 may control only the blue LED 190B to turn on.

However, when an ON signal of the green LED 190G is received, the processor 91 may control the green LED 190G and the blue LED 190B to turn on, and when an ON signal of the red LED 190R is received, the processor 91 may control the red LED 190R and the blue LED 190B to turn on.

That is, compared to generating green light or red light using only the green LED 190G or red LED 190R, light efficiency may be increased by driving the green LED 190G or red LED 190R at a relatively low current while simultaneously driving the more efficient blue LED 190B.

According to one or more embodiments of the disclosure, a display apparatus may include: a liquid crystal panel; a backlight unit configured to provide light to the liquid crystal panel; a quantum dot (QD) sheet between the liquid crystal panel and the backlight unit, and including QD particles; and at least one processor configured to control the liquid crystal panel and the backlight unit, wherein the backlight unit includes: a substrate; and a plurality of light-emitting devices, each of the plurality of light-emitting devices including a red light-emitting diode (LED), a green LED, and a blue LED, and the at least one processor is further configured to, based on an ON signal of an LED having a color identical to a color of the QD particles of the QD sheet, control the backlight unit to turn the blue LED on together with the LED that receives the ON signal, and the LED having the color identical to the color of the QD particles of the QD sheet is one of the red LED and the green LED. The term “identical” is interchangeable with the term “same” throughout this disclosure; for example, the color of a green QD particle and the color of a green LED are the “same”/“identical”, and the color of a red QD particle and the color of a red LED are the “same”/“identical”.

According to the disclosure, light efficiency of green LED or red LED may be increased by combining a backlight unit including red, green, and blue LEDs with a QD sheet.

In addition, power consumption may be reduced due to the increased light efficiency.

The QD sheet may include a QD sheet of green QD particles.

The processor may be configured to control the backlight unit to turn the blue LED on together with the green LED, based on an ON signal of the green LED.

The QD sheet may include a QD sheet of red QD particles.

The processor may be configured to control the backlight unit to turn the blue LED on together with the red LED, based on an ON signal of the red LED.

The QD sheet may include a QD sheet of green QD particles and red QD particles.

The processor may be configured to: control the backlight unit to turn the blue LED on together with the green LED, based on an ON signal of the green LED, and control the backlight unit to turn the blue LED on together with the red LED, based on an ON signal of the red LED.

According to one or more embodiments of the disclosure, there is provided a method for controlling a display apparatus including a liquid crystal panel, a backlight unit configured to provide light to the liquid crystal panel and including a plurality of light-emitting devices, and a quantum dot (QD) sheet between the liquid crystal panel and the backlight unit and including QD particles, each of the plurality of light-emitting devices including a red light-emitting diode (LED), a green LED, and a blue LED, the method including: receiving an ON signal of an LED having a color identical to a color of the QD particles of the QD sheet, the LED having the color identical to the color of the QD particles of the QD sheet is one of the red LED and the green LED; and controlling the backlight unit to turn on the blue LED and the LED that receives the ON signal, based on the ON signal of the LED having the color identical to the color of the QD particles of the QD sheet.

The QD sheet may include a QD sheet of green QD particles.

The controlling of the backlight unit may include controlling the backlight unit to turn the blue LED on together with the green LED, based on an ON signal of the green LED.

The QD sheet may include a QD sheet of red QD particles.

The controlling of the backlight unit may include controlling the backlight unit to turn the blue LED on together with the red LED, based on an ON signal of the red LED.

The QD sheet may include a QD sheet of green QD particles and red QD particles.

The controlling of the backlight unit may include controlling the backlight unit to turn the blue LED on together with the green LED, based on an ON signal of the green LED, and the controlling the backlight unit may also include to turn the blue LED on together with the red LED, based on an ON signal of the red LED.

According to the disclosure, light efficiency of green LED or red LED may be increased by combining a backlight unit including red, green, and blue LEDs with a QD sheet.

In addition, power consumption may be reduced due to the increased light efficiency.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a non-transitory computer-readable recording medium.

The computer-readable recording medium may include all kinds of recording media storing instructions that can be interpreted by a computer. For example, the computer-readable recording medium may be ROM, RAM, a magnetic tape, a magnetic disc, a flash memory, an optical data storage device, etc.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

What is claimed is:

1. A display apparatus comprising:
a liquid crystal panel;
a backlight unit configured to provide light to the liquid crystal panel;
a quantum dot (QD) sheet between the liquid crystal panel and the backlight unit, and comprising QD particles; and
at least one processor configured to control the liquid crystal panel and the backlight unit,
wherein the backlight unit comprises:
a substrate; and
a plurality of light-emitting devices, each of the plurality of light-emitting devices comprising a red light-emitting diode (LED), a green LED, and a blue LED, and
wherein the at least one processor is further configured to, based on an ON signal of an LED having a color identical to a color of the QD particles of the QD sheet, control the backlight unit to turn on the blue LED and the LED that receives the ON signal, and the LED having the color identical to the color of the QD particles of the QD sheet is one of the red LED and the green LED.

2. The display apparatus of claim 1, wherein the QD particles of the QD sheet comprise green QD particles.

3. The display apparatus of claim 2, wherein the at least one processor is further configured to control the backlight unit to turn on the blue LED and the green LED, based on an ON signal of the green LED.

4. The display apparatus of claim 1, wherein the QD particles of the QD sheet are red QD particles.

5. The display apparatus of claim 4, wherein the at least one processor is further configured to control the backlight unit to turn on the blue LED and the red LED, based on an ON signal of the red LED.

6. The display apparatus of claim 1, wherein the QD particles of the QD sheet comprise green QD particles and red QD particles.

7. The display apparatus of claim 6, wherein the at least one processor is configured to:
control the backlight unit to turn on the blue LED and the green LED, based on an ON signal of the green LED, and
control the backlight unit to turn on the blue LED and the red LED, based on an ON signal of the red LED.

8. A method for controlling a display apparatus comprising a liquid crystal panel, a backlight unit configured to provide light to the liquid crystal panel and comprising a plurality of light-emitting devices, and a quantum dot (QD) sheet between the liquid crystal panel and the backlight unit and including QD particles, each of the plurality of light-emitting devices comprising a red light-emitting diode (LED), a green LED, and a blue LED, the method comprising:
receiving an ON signal of an LED having a color identical to a color of the QD particles of the QD sheet, the LED having the color identical to the color of the QD particles of the QD sheet is one of the red LED and the green LED; and
controlling the backlight unit to turn on the blue LED and the LED that receives the ON signal, based on the ON signal of the LED having the color identical to the color of the QD particles of the QD sheet.

9. The method of claim 8, wherein the QD particles comprise green QD particles.

10. The method of claim 9, wherein the controlling the backlight unit comprises controlling the backlight unit to turn on the blue LED and the green LED, based on an ON signal of the green LED.

11. The method of claim 8, wherein the QD particles comprise red QD particles.

12. The method of claim 11, wherein the controlling the backlight unit comprises controlling the backlight unit to turn on the blue LED and the red LED, based on an ON signal of the red LED.

13. The method of claim 8, wherein the QD particles comprise green QD particles and red QD particles.

14. The method of claim 13, wherein the controlling of the backlight unit comprises:
controlling the backlight unit to turn on the blue LED and the green LED, based on an ON signal of the green LED; and
controlling the backlight unit to turn on the blue LED and the red LED, based on an ON signal of the red LED.

15. The method of claim 13, further comprising:
controlling the backlight unit to turn on only the blue LED, based on an ON signal of the blue LED.
